(19) United States
(12) Patent Application Publication
(10) Pub. No.: US 2026/0351903 A1
(43) Pub. Date: Nov. 5, 2026

(54) CONNECTOR WITH CONTACT SUPPORT STRUCTURE

(71) Applicant: Molex, LLC, Lisle, IL (US)

(72) Inventors: Dominic Steier, Naperville, IL (US); Chee Kit Chew, Jurong Town (SG)

(21) Appl. No.: 19/105,049

(22) PCT Filed: Sep. 11, 2023
(86) PCT No.: PCT/IB2023/058984

§ 371 Date: Feb. 20, 2025

Related U.S. Application Data
(60) Provisional application No. 63/406,264, filed on Sep. 14, 2022.

(51) Int. Cl. H01R 13/6471; H01R 13/6585

(52) U.S. Cl. CPC H01R 13/6471; H01R 13/6585

(57) ABSTRACT

Aspects of a connector with a contact support structure are described herein. An example connector includes a housing, a wafer assembly including a terminal row and a wafer molding insert, and a wafer assembly support bar. The terminal row includes a plurality of terminal conductors. The wafer assembly support bar includes a terminal seat surface, a datum surface, and a molding interlock. A terminal conductor among the plurality of terminal conductors is electrically coupled to the terminal seat surface, and the wafer molding insert is molded and extends into the molding interlock to secure the terminal row with respect to the datum surface. Thus, the terminal row is secured with the support bar and the wafer molding insert. As compared to other designs, the support bar provides additional strength, a higher modulus of elasticity, and thermal stability.

### CROSS-REFERENCE TO RELATED APPLICATIONS

This application claims the benefit of U.S. Provisional Application No. 63/406,264, filed Sep. 14, 2022, the contents of which are hereby incorporated by reference in their entirety.

### BACKGROUND

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. As one example, a wire-to-board system includes a free-end connector attached to a wire and a fixed-end connector attached to a board.

For high data rate applications in which physical space is constrained, as one example, it can be challenging to design interconnection system connectors, due to a number of competing concerns. High data rate interconnection systems often rely upon differentially coupled signal pairs in which two conductors are arranged in a pair to transmit a differential signal. The signal being transmitted is embodied by the electrical difference measured between the conductor pair. Differential signaling can be helpful to avoid spurious signals and crosstalk and avoid inadvertent signaling modes among adjacent signals pairs. In connector interfaces, ground terminals can be relied upon to create a return path to electrical ground, provide shielding between differential pairs, and for other purposes.

Connectors used in high data rate applications are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the terminal conductors in the wafer assemblies. The use of wafer assemblies can be helpful to manufacture connectors capable of achieving high data rates using a number of different assembly processes. It is still challenging, in any case, to design wafers having the conductor density and small footprint needed for high data rate applications in new systems, while also maintaining the desired electrical characteristics for the transmission of data with integrity.

### SUMMARY

Aspects of a connector with a contact support structure are described. An example connector includes a housing, a wafer assembly including a terminal row and a wafer molding insert, and a wafer assembly support bar. The terminal row includes a plurality of terminal conductors. The wafer assembly support bar includes a terminal seat surface, a datum surface, and a molding interlock. A terminal conductor among the plurality of terminal conductors is electrically coupled to the terminal seat surface, and the wafer molding insert is molded and extends into the molding interlock to secure the terminal row with respect to the datum surface. Thus, the terminal row is secured with the support bar and the wafer molding insert. As compared to other designs, the support bar provides additional strength, a higher modulus of elasticity, and thermal stability. In other aspects of the embodiments, the wafer assembly support bar is embodied or formed from metal, and the wafer molding insert is embodied or formed from plastic. The wafer assembly support bar includes a first arm, a second arm, and an extension bar that extends between the first arm and the second arm. The first arm and the second arm define sides of a front port opening of the connector. The extension bar of the wafer assembly support bar comprises the molding interlock, and at least one of the first arm and the second arm comprises the datum surface.

In other aspects, the plurality of terminal conductors include a plurality of ground conductors and a plurality of signal conductors, the wafer assembly support bar includes a plurality of terminal seat surfaces, and individual ones of the plurality of ground conductors are electrically coupled to respective ones of the plurality of terminal seat surfaces. The wafer assembly support bar further includes a terminal recess positioned between a pair of the plurality of terminal seat surfaces. A pair of signal conductors among the plurality of signal conductors extends through the terminal recess of the wafer assembly support bar, surrounded by the wafer molding insert.

In other aspects of the embodiments, the connector includes a ground path assembly. The ground path assembly includes a ground channel block, and the ground channel block includes a plurality of channels. A pair of signal conductors among the plurality of terminal conductors extend along a channel among the plurality of channels. In one example, the ground channel block includes metal plating over a plastic body. In other aspects, the ground channel block includes a plurality of grounding ribs for surface mounting at a terminal foot of the connector. The channel extends between a pair of the plurality of grounding ribs at the terminal foot of the connector. In another aspect, the ground channel block includes a grounding bar that extends between and is electrically coupled to the plurality of grounding ribs of the ground channel block. The plurality of grounding ribs are integrally formed with the ground channel block in one example.

In another example, the ground channel block includes metal plating over a plastic body, and the plurality of grounding ribs are separate from the ground channel block and formed from metal. In other aspects, the ground path assembly further includes a ground platform frame, and major surfaces of the ground platform frame extend in a plane that extends parallel to major surfaces of the plurality of grounding ribs at a terminal foot of the connector.

Another example connector includes a wafer assembly including a terminal row and a wafer molding insert, and a wafer assembly support bar. The wafer assembly support bar includes a molding interlock, and the wafer molding insert is molded and extends into the molding interlock of the wafer assembly support bar. The wafer assembly support bar includes a terminal seat surface in one example, and a ground conductor of terminal row is electrically coupled to the terminal seat surface of the wafer assembly support bar. The wafer assembly support bar includes a first arm, a second arm, and an extension bar that extends between the first arm and the second arm in one example, and the first arm and the second arm define sides of a front port opening of the connector.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a perspective view of an example connector according to various embodiments of the present disclosure.

FIG. 2 illustrates a perspective front view of the connector shown in FIG. 1, with the housing omitted, according to various embodiments of the present disclosure.

FIG. 3 illustrates a perspective back view of the connector shown in FIG. 1, with the housing omitted, according to various embodiments of the present disclosure.

FIG. 4 illustrates the support bars of the connector shown in FIG. 1 according to various embodiments of the present disclosure.

FIG. 5 illustrates the cross-sectional view A-A of a support bar shown in FIG. 4.

FIG. 6 illustrates a detail view of support bars and terminal rows at one side of the connector shown in FIG. 1 according to various embodiments of the present disclosure.

FIG. 7 illustrates a detail view of a terminal row and wafer molding insert of the connector shown in FIG. 1 according to various embodiments of the present disclosure.

FIG. 8 illustrates another detail view of the terminal row shown in FIG. 7 with the wafer molding insert omitted.

FIG. 9 illustrates a top perspective view of a terminal row and wafer molding inserts in the connector shown in FIG. 1 according to various embodiments of the present disclosure.

FIG. 10 illustrates a bottom perspective view of a terminal row and wafer molding inserts in the connector shown in FIG. 1 according to various embodiments of the present disclosure.

FIG. 11 illustrates a top perspective view of a terminal row and wafer molding inserts in the connector shown in FIG. 1 according to various embodiments of the present disclosure.

FIG. 12 illustrates a bottom perspective view of a terminal row and wafer molding inserts in the connector shown in FIG. 1 according to various embodiments of the present disclosure.

FIG. 13 illustrates a front perspective view of ground channel blocks in the connector shown in FIG. 1 according to various embodiments of the present disclosure.

FIG. 14 illustrates a back perspective view of ground channel blocks in the connector shown in FIG. 1 according to various embodiments of the present disclosure.

FIG. 15 illustrates a front perspective view of ground frames in the connector shown in FIG. 1 according to various embodiments of the present disclosure.

FIG. 16 illustrates a back perspective view of ground frames in the connector shown in FIG. 1 according to various embodiments of the present disclosure.

FIG. 17 illustrates a back perspective view of ground frames in the connector shown in FIG. 1 according to various embodiments of the present disclosure.

FIG. 18 illustrates a perspective view of a terminal foot of the connector shown in FIG. 1 according to various embodiments of the present disclosure.

FIG. 19 illustrates a side view of grounding ribs of the connector shown in FIG. 1 according to various embodiments of the present disclosure.

FIG. 20 illustrates a side view of other grounding ribs according to various embodiments of the present disclosure.

FIG. 21 illustrates a connector with grounding ribs and a ground platform frame according to various embodiments of the present disclosure.

FIG. 22 illustrates a side view of a metal rib insert according to various embodiments of the present disclosure.

FIG. 23 illustrates a top view of a ground platform frame according to various embodiments of the present disclosure.

### DETAILED DESCRIPTION

Connectors are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the terminal conductors in the wafer assemblies. The use of wafer assemblies can be helpful to manufacture connectors capable of high data rates using a range of different assembly processes. It is still challenging, in any case, to design wafers and connectors having the conductor density and small footprint needed for high data rate applications in new systems, while also maintaining the desired electrical characteristics for the transmission of data with integrity.

In the context outlined above, various aspects and embodiments of connectors with contact support structures and other features are described herein. An example connector includes a housing, a wafer assembly including a terminal row and a wafer molding insert, and a wafer assembly support bar. The terminal row includes a plurality of terminal conductors. The wafer assembly support bar includes a terminal seat surface, a datum surface, and a molding interlock. A terminal conductor among the plurality of terminal conductors is electrically coupled to the terminal seat surface, and the wafer molding insert is molded and extends into the molding interlock to secure the terminal row with respect to the datum surface. Thus, the terminal row is secured with the support bar and the wafer molding insert. As compared to other designs, the support bar provides additional strength, a higher modulus of elasticity, and thermal stability.

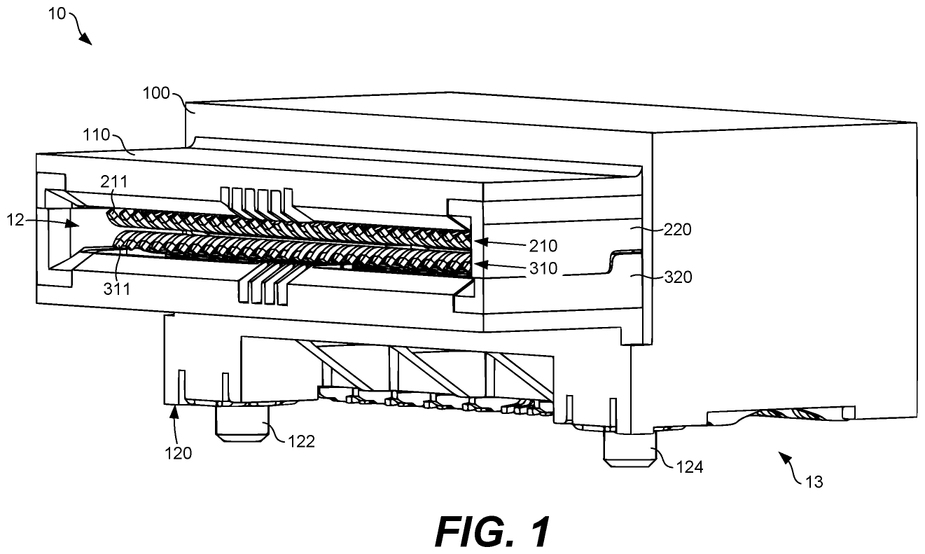

Turning to the drawings, FIG. 1 illustrates a perspective view of an example connector 10 according to various embodiments of the present disclosure. The connector 10 is illustrated as a representative example and is not drawn to any particular scale or size. The shape, size, proportion, and other characteristics of the connector 10 can vary as compared to that shown. For example, the connector 10 can accommodate larger or smaller rows of terminals (e.g., be wider or narrower), and other variations are within the scope of the examples described herein. A number of connectors similar to the connector 10 can be stacked or arranged side-by-side, for higher data rate interconnections. Additionally, one or more of the parts or components of the connector 10, as illustrated in the drawings and described herein, can be omitted in some cases. The connector 10 can also include other parts or components that are not illustrated.

The connector 10 includes a front port opening 12 and a terminal foot 13. The connector 10 is designed to establish and maintain electrical connections with contacts on the free end interface of a cable assembly. For example, a printed circuit board (PCB)-style interface of an Octal Small Form Factor Pluggable (OSFP), Quad Small Form Factor Pluggable (QSFP), or similar cable assembly can be inserted into the front port opening 12 of the connector 10.

The connector 10 includes rows of terminal conductors that extend from the front port opening 12 to the terminal foot 13, for the communication of data signals on the conductors. The connector 10 is designed to provide shielding and maintain the signal integrity of differential signals on the terminal conductors, as they extend from the front port opening 12 to the terminal foot 13. The connector 10 can be designed for use with OSFP, QSFP, or related interconnection systems, although the concepts described herein are not limited to use with any particular type or style of interconnect system. Additionally, the terminal foot 13 of the connector 10 can be designed as a Surface-Mount Technology (SMT) foot, for coupling to the surface of a larger board or assembly, but the connector 10 can also be designed to have through-hole leads or other lead styles at the terminal foot 13 in some cases.

As shown in FIG. 1, the connector includes a housing 100, support bars 220 and 320, and terminal rows 210 and 310 positioned within the opening 12. The housing 100 can be formed from a plastic or other insulating material, in one example, although the housing can also be formed from metal or combinations of insulating and conductive materials in some cases. The housing includes a front port 110, a bottom mounting surface 120, and mounting posts 122 and 124. The connector 10 is adapted to receive the PCB-style tip of an OSFP, QSFP, or related type of a cable system in one example. The PCB-style tip of the cable system can fit into the opening 12 of the connector. When inserted, terminal rows 210 and 310 within the housing 100, including terminal conductors 211 and 311, among others, will seat upon and make electrical contact with contacts on the top and bottom surfaces of the PCB-style tip.

The alignment and positions of the terminal conductors within the connector 10 is particularly important. The mechanical compliance and robustness of each terminal conductor in the terminal rows 210 and 310 within the housing 100 should be consistent with each other, across the terminal rows 210 and 310. Designing a connector having terminal rows that do not vary in mechanical robustness, bend or curve at the center (or other location), or exhibit other mechanical or electrical variations can be difficult, particularly when the terminal rows are relatively wide. Additionally, heat is often relied upon when the connector 10 is mounted to the surface of a larger board or assembly, and the application of heat can relax the internal wafer molding supports within the connector 10, sometimes altering the mechanical or electrical performance of the terminal conductors.

In the context outlined above, the connector 10 includes support bars 220 and 320. The support bars 220 and 320 are formed from a material that is relatively rigid and has a high modulus of elasticity, even when heated. Among other examples described herein, the support bars 220 and 320 can be formed from metal, such as aluminum, copper, or another metal or metal alloys that are rigid and thermally stable. Wafer assemblies within the connector 10 can be molded into molding interlocks of the support bars 220 and 320, and terminal conductors can be mechanically and electrically secured (i.e., soldered or welded) to terminal seat surfaces on the support bars 220 and 320. Thus, the wafer assemblies can be mechanically and electrically integrated with the support bars 220 and 320, to provide additional strength and dimensional accuracy for the terminal rows in the wafer assemblies. The support bars 220 and 320 thus provide a common electrical path between ground terminals in the terminal rows.

Additionally, as shown in FIG. 1, the ends of the support bars 220 and 320 define the sides of the opening 12 in the connector. In that arrangement, surfaces at the ends of the support bars 220 and 320 provide datum surfaces, and the positions of the terminal conductors with respect to the datum surfaces can be manufactured with better precision. The positions can be maintained even under mechanical stress and heat cycles. PCB-style tips of cable systems can fit into the opening 12 of the connector 10 and, based on contact with the datum surfaces of the support bars 220 and 320, find alignment with the terminal rows of conductors in the housing 100. These and other features of the housing 100 are described in additional detail below.

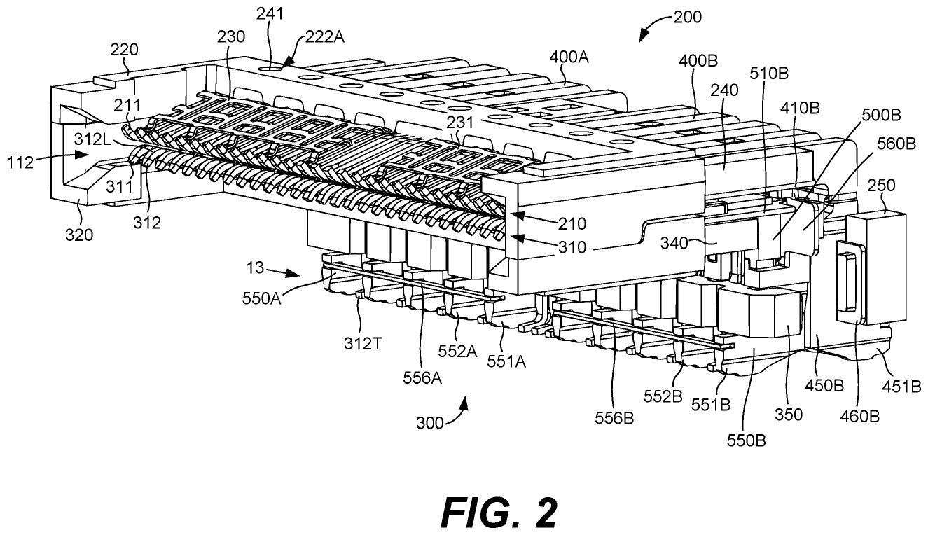

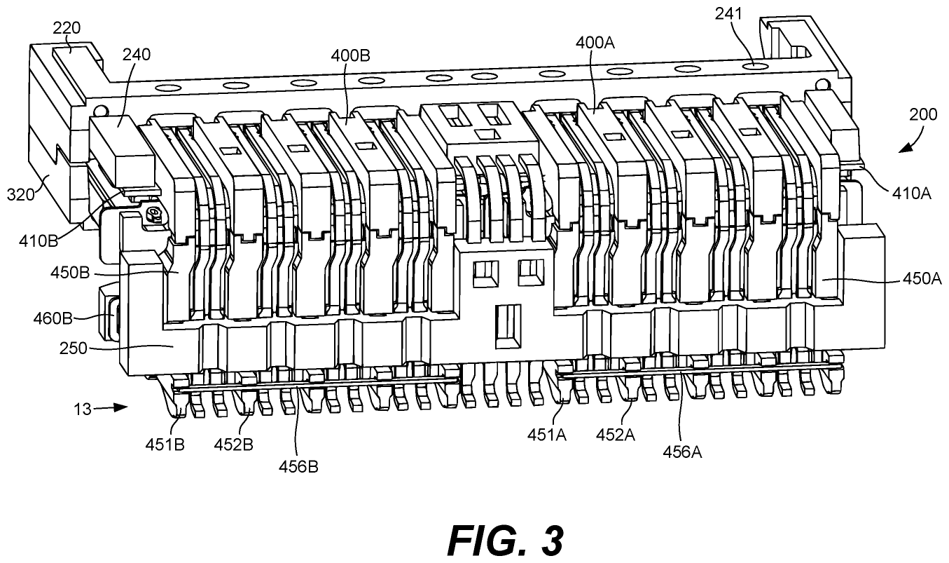

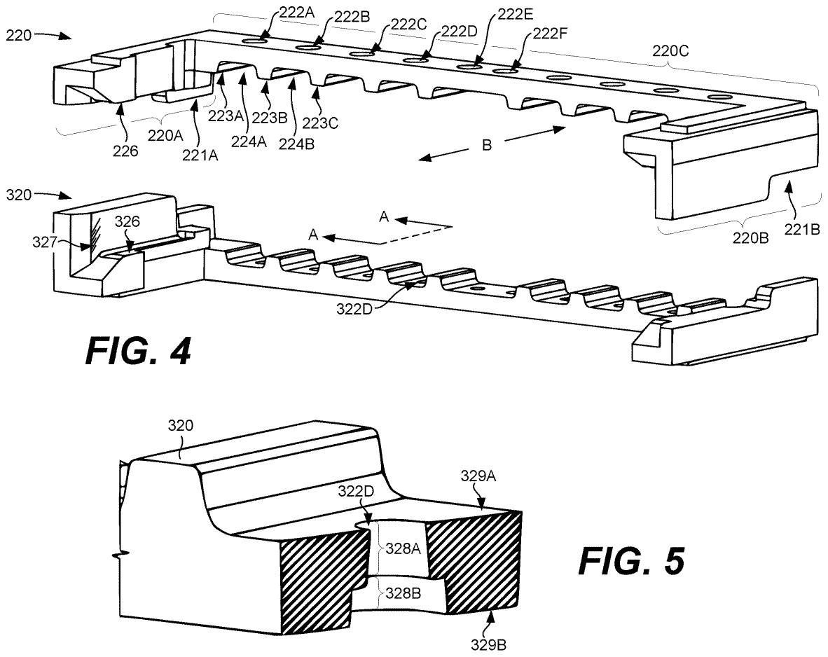

FIG. 2 illustrates a perspective front view of the connector 10 shown in FIG. 1, with the housing 100 omitted from view, and FIG. 3 illustrates a perspective back view of the connector 10. Inside the housing 100, the connector 10 includes a first or upper wafer assembly 200, a second or lower wafer assembly 300, the support bars 220 and 320, and ground path assemblies. The assemblies of the connector 10 are first described with reference to FIGS. 2 and 3, and detail views of the assemblies are then described with reference to FIGS. 4-19.

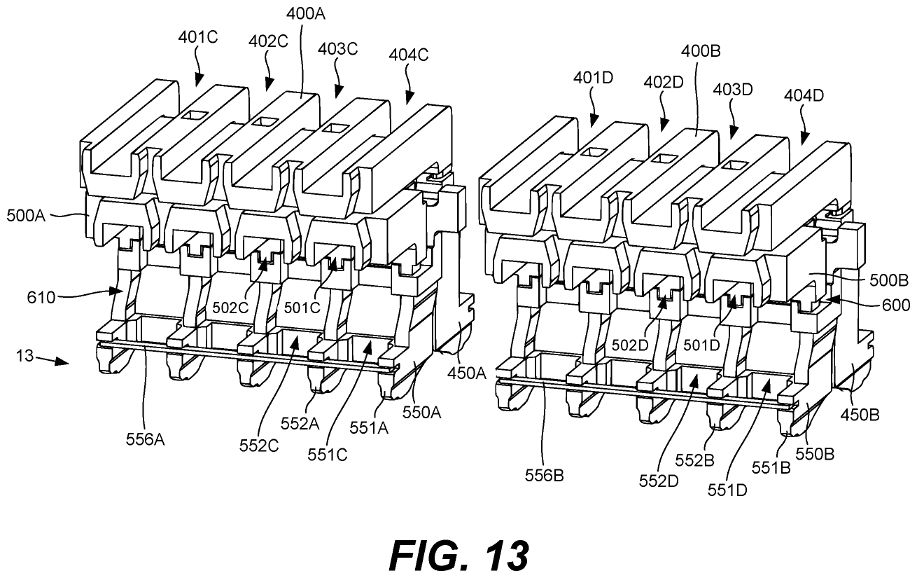

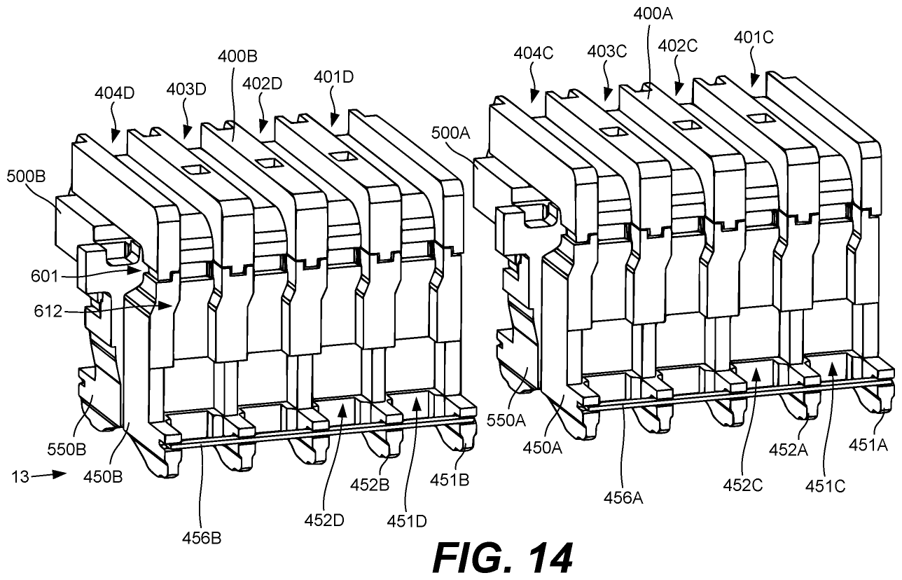

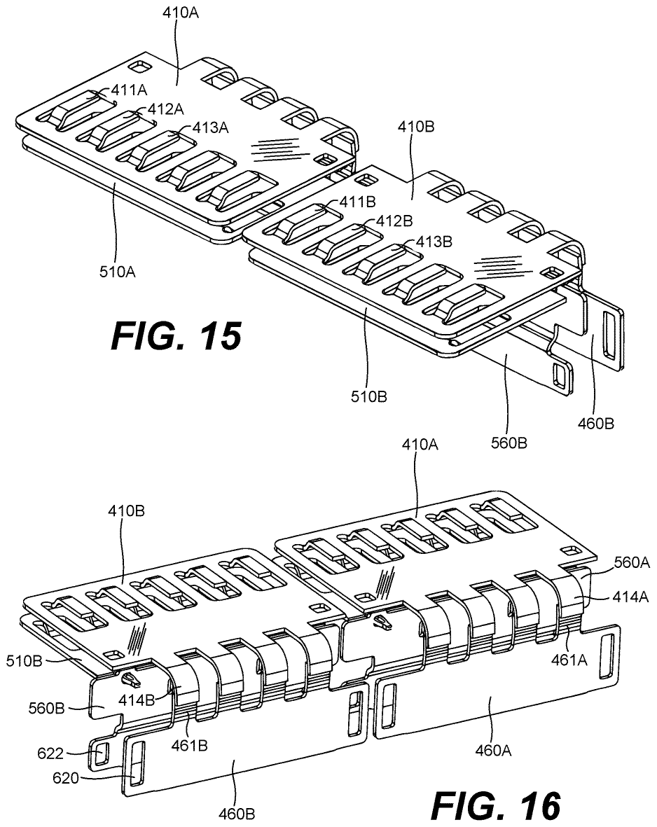

The wafer assembly 200 includes the terminal row 210, flexible shields 230 and 231, and wafer molding inserts 240 and 250, among possibly other components. Along with the support bar 220, the wafer assembly 200 supports, spaces, and aligns terminal conductors in the terminal row 210. The connector 10 also includes a ground path assembly for the wafer assembly 200. The ground path assembly for the wafer assembly 200 includes upper ground channel blocks 400A and 400B and lower ground channel blocks 450A and 450B. The blocks 400A, 400B, 450A, and 450B are also illustrated separately in FIGS. 13 and 14. The ground path assembly also includes ground frames 410A and 410B for the upper ground channel blocks 400A and 400A, respectively, and ground frames 460A and 460B for the lower ground channel blocks 450A and 450B. The ground frames 410A, 410B, 460A, and 460B are also illustrated separately in FIGS. 15-17.

The terminal row 210 includes signal conductors, power conductors, and ground conductors. The signal and power conductors in the terminal row 210 each include a lead contact at one distal end (i.e., positioned at the front port opening 12 of the connector 10, as shown in FIG. 1), a tail contact at another distal end (i.e., positioned at the terminal foot 13), and a conductor bend between the lead contact and the tail contact. The signal and power conductors in the terminal row 210 are electrically isolated from each other within the connector 10. The signal and power conductors extend, starting from the lead contacts at the front port opening 12, to the tail contacts at the terminal foot 13 of the connector 10. The tail contacts of the signal and power conductors can be formed as SMT tail contacts, as in the example shown, or through-hole or other types of contacts.

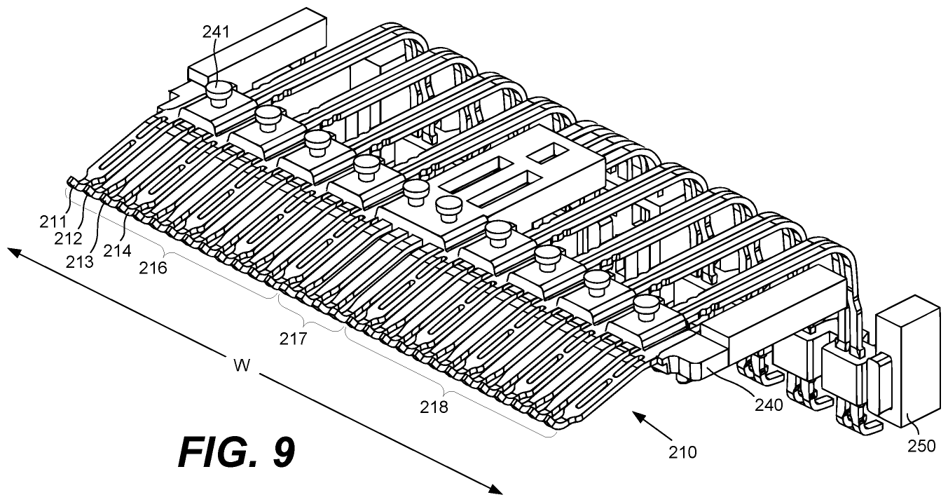

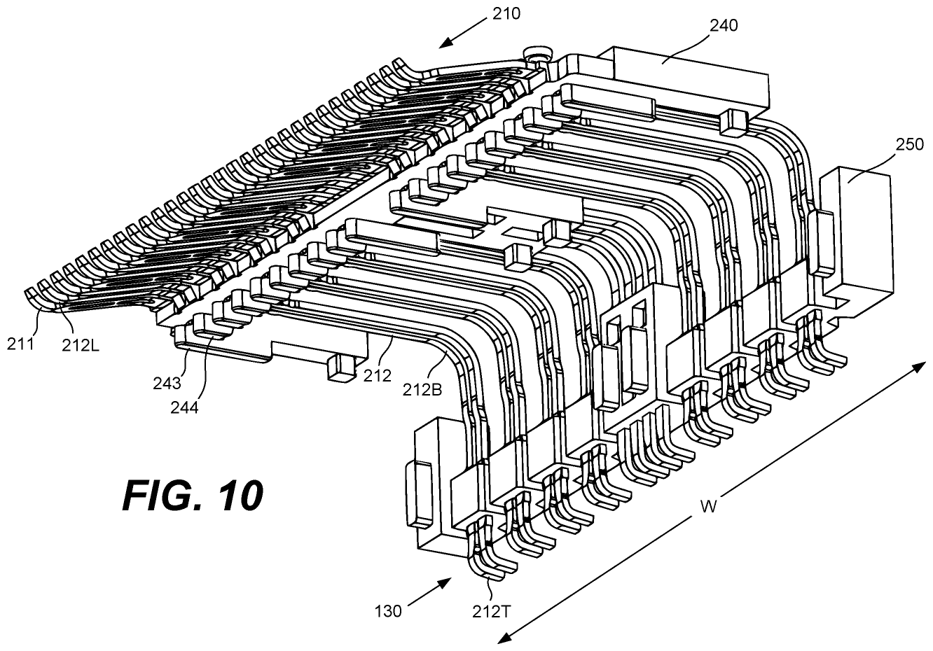

The ground conductors in the terminal row 210 each include a lead contact at one distal end and a tail contact at another distal end. The ground conductors extend from lead contacts within at the front port opening 12 to contact points on the ground path assembly for the wafer assembly 200, as also described below. The ground path assembly includes a number of grounding ribs or fins for surface mounting to a board at the terminal foot 13. Additional views of the terminal row 210 are provided in FIGS. 9 and 10.

The terminal row 210 can be formed (e.g., stamped, sheared, or otherwise formed) from a flat sheet of metal. In some cases, the sheet of metal can be plated with one or more plating metals. The wafer molding inserts 240 and 250 can be formed from a plastic, such as liquid crystal polymer (LCP) or other insulating material(s) and are molded around the terminal conductors in the terminal row 210. The wafer molding inserts 240 and 250 are separated from each other, along the length of the terminal conductors in the terminal row 210, and a bend is formed in the terminal row 210 between the wafer molding inserts 240 and 250.

The flexible shields 230 and 231 can be formed (e.g., stamped, sheared, or otherwise formed) from a flat sheet of metal and plated in some cases. The flexible shields 230 and 231 are secured to a top surface of the ground conductors in the terminal row 210, within openings through the ground conductors, using mechanical interferences. The flexible shields 230 and 231 span over (but do not contact) signal conductors in the terminal row 210, to provide shielding for the signal conductors. The flexible shields 230 and 231 provide additional support for the ground conductors in the terminal row 210 and shield the signal conductors in the terminal row 210, to maintain electrical ground couplings and maintain data signal integrity. Although not illustrated in FIG. 2, the terminal row 310 also includes flexible shields.

The upper ground channel blocks 400A and 400B and lower ground channel blocks 450A and 450B can be formed as insulating blocks or bodies covered with one or more plating metals, in one example. As examples, the blocks 400A, 400B, 450A, and 450B can be formed from LCP, polyethylene (PE), polytetrafluoroethylene (PTFE), conductive PE or PTFE, fluoropolymer, or other plastic or insulating materials. The blocks 400A, 400B, 450A, and 450B can be plated with tin, gold, or another plating metal or metals. In other cases, the ground channel blocks 400A and 400B can be formed from metal or other conductive materials, with or without plating. The signal conductors of the terminal row 210 extend within channels formed in the blocks 400A, 400B, 450A, and 450B, which help to prevent signal crosstalk and interference among them. The lower ground channel blocks 450A and 450B include grounding ribs, including grounding ribs 451A and 452A of the block 450A and grounding ribs 451B and 451B of the block 450B, among others, as shown in FIG. 3.

Referring to FIG. 3, the ground channel block 450A includes a grounding bar 456A, and the ground channel block 450B includes a grounding bar 456B. The grounding bars 456A and 456B can be formed from metal, such as aluminum, copper, zinc, stainless steel, or other metals or metal alloys, and be plated with one or more plating metals in some cases. The grounding bar 456A extends between and is electrically coupled to the grounding ribs of the ground channel block 450A, for ground communing and to maintain a common voltage potential among the grounding ribs. Similarly, the grounding bar 456B extends between and is electrically coupled to the grounding ribs of the ground channel block 450B, for ground communing and to maintain a common voltage potential among the grounding ribs. Additional aspects of the ground path assembly for the wafer assembly 300 are described below.

The wafer molding inserts 240 and 250 are molded or otherwise formed around the terminal row 210. Before the wafer molding inserts 240 and 250 are formed, one or more of the ground conductors in the terminal row 210 can be mechanically and electrically secured (e.g., soldered, welded, adhered, etc.) to terminal seat surfaces of the support bar 220. The terminal row 210 and support bar 220 can then be inserted into a mold fixture, and LCP or another insulating material can be injected into the mold. The insulating material forms the wafer molding inserts 240 and 250 around the terminal row 210, and the insulating material also flows into molding interlocks of the support bar 220. The wafer molding insert 240 is thus anchored and secured with the support bar 220.

For example, FIGS. 2 and 3 illustrate how the material of the wafer molding insert 240 extends into an interlock aperture 222A of the support bar 220, forming an interlock plug 241. The support bar 220 includes a number of interlock apertures, and the wafer molding insert 240 extends through each of the interlock apertures, forming a number of interlock plugs. In that way, the terminal row 210 is secured with the support bar 220 and the wafer molding insert 240. As compared to other designs, the support bar 220 provides additional strength, a higher modulus of elasticity, and better thermal stability. The support bar 220 also provides additional benefits described herein. Other aspects of the arrangement of the terminal row 210, the support bar 220, and the wafer molding insert 240 are described below.

The wafer assembly 300 includes the terminal row 310, flexible shields (not shown in FIGS. 2 and 3), and wafer molding inserts 340 and 350, among possibly other components. Along with the support bar 320, the wafer assembly 300 supports, spaces, and aligns the terminal conductors in the terminal row 310. The connector 10 also includes a ground path assembly for the wafer assembly 300. The ground path assembly for the wafer assembly 300 includes upper ground channel blocks 500A and 500B and lower ground channel blocks 550A and 550B. The blocks 500A, 500B, 550A, and 550B are also illustrated separately in FIGS. 13 and 14. The ground path assembly also includes ground frames 510A and 510B for the upper ground channel blocks 500A and 500B, respectively, and ground frames 560A and 560B for the lower ground channel blocks 550A and 550B. The ground frames 510A, 510B, 560A, and 560B are also illustrated separately in FIGS. 15-17.

The terminal row 310 includes signal conductors, power conductors, and ground conductors. The signal and power conductors in the terminal row 310 each include a lead contact at one distal end (i.e., positioned at the front port opening 12 of the connector 10, as shown in FIG. 1), a tail contact at another distal end (i.e., positioned at the terminal foot 13), and a conductor bend between the lead contact and the tail contact. The signal and power conductors in the terminal row 310 are electrically isolated from each other within the connector 10. The signal and power conductors extend, starting from lead contacts at the front port opening 12, to the tail contacts at the terminal foot 13 of the connector 10. As one example, the signal conductor 312 extends from a lead contact 312L end at the front port opening 12 to a tail contact 312T end at the terminal foot 13. The tail contacts of the signal and power conductors can be formed as SMT tail contacts, as in the example shown, or through-hole or other types of contacts.

The ground conductors in the terminal row 310 each include a lead contact at one distal end and a tail contact at another distal end. The ground conductors extend from lead contacts within at the front port opening 12 to contact points on the ground path assembly for the wafer assembly 300, as also described below. The ground path assembly includes a number of grounding ribs or fins for surface mounting to a board at the terminal foot 13. Additional views of the terminal row 210 are provided in FIGS. 9 and 10.

The terminal row 310 can be formed (e.g., stamped, sheared, or otherwise formed) from a flat sheet of metal. In some cases, the sheet of metal can be plated with one or more plating metals. The wafer molding inserts 340 and 350 can be formed from a plastic, such as LCP or other insulating material(s) and are molded around the terminal conductors in the terminal row 310. The wafer molding inserts 340 and 350 are separated from each other, along the length of the terminal conductors in the terminal row 310, and a bend is formed in the terminal row 310 between the wafer molding inserts 340 and 350.

The upper ground channel blocks 500A and 500B and lower ground channel blocks 550A and 550B can be formed as plastic blocks covered with one or more plating metals, in one example, although the blocks can also be formed from metal or other conductive materials. As examples, the blocks 500A, 500B, 550A, and 550B can be formed from LCP, PE, PTFE, conductive PE or PTFE, fluoropolymer, or other plastic or insulating materials. The signal conductors of the terminal row 310 extend within channels formed in the blocks 500A, 500B, 550A, and 550B, which help to prevent signal crosstalk and interference among them. The ground channel blocks 550A and 550B include grounding ribs. As examples, the ground channel block 550A includes the grounding ribs 551A and 552A, among others, and the ground channel block 550B includes the grounding ribs 551B and 552B, among others, as shown in FIG. 2.

Referring to FIG. 2, the ground channel block 550A includes a grounding bar 556A, and the ground channel block 550B includes a grounding bar 556B. The grounding bars 556A and 556B can be formed from metal, such as aluminum, copper, zinc, stainless steel, or other metals or metal alloys, and be plated with one or more plating metals in some cases. The grounding bar 556A extends between and is electrically coupled to the grounding ribs of the ground channel block 550A, for ground communing and to maintain a common voltage potential among the grounding ribs. Similarly, the grounding bar 556B extends between and is electrically coupled to the grounding ribs of the ground channel block 550B, for ground communing and to maintain a common voltage potential among the grounding ribs. Additional aspects of the ground path assembly for the wafer assembly 300 are described below.

The wafer molding inserts 340 and 350 are molded or otherwise formed around the terminal row 310. Before the wafer molding inserts 340 and 350 are formed, one or more of the ground conductors in the terminal row 310 can be electrically and mechanically secured (e.g., soldered, welded, adhered, etc.) to terminal seat surfaces of the support bar 320. When the wafer molding insert 340 is molded, the insulating material of the wafer molding insert 340 flows into molding interlocks of the support bar 320, to anchor and secure the wafer molding insert 340 with the support bar 320. This is similar to how the wafer molding insert 240 is anchored with the support bar 220. In that way, the terminal row 310 is secured with the support bar 320 and the wafer molding insert 340. As compared to other designs, the support bar 320 provides additional strength, a higher modulus of elasticity, and thermal stability. The support bar 320 also provides additional benefits described herein. Other aspects of the arrangement of the terminal row 310, the support bar 320, and the wafer molding insert 340 are described below.

FIG. 4 illustrates the support bars 220 and 320, separated from each other, with all other components of the connector 10 omitted from view. The support bars 220 and 320 are illustrated as a representative example in FIG. 4. The size, shape, and style of the support bars 220 and 320 can vary as compared to that shown. For example, the number and positions of the interlock features, the terminal seat surfaces, and other features of the support bars 220 and 320 can vary from that shown. The support bars 220 and 320 can be formed from metal, such as aluminum, copper, zinc, stainless steel, or other metals or metal alloys that are relatively rigid and have a high modulus of elasticity, even when heated. The support bars 220 and 320 are preferably formed from a material having a higher rigidity and modulus of elasticity the wafer molding inserts 240, 250, 340, and 350. The support bars 220 and 320 can be molded, milled, or formed from other suitable manufacturing techniques. The support bars 220 and 320 can also be plated with one or more metals in some cases.

In the example shown in FIG. 4, the support bars 220 and 320 are formed to have the same shape and size, and the support bar 320 is rotated 180° along the axis “B,” as compared to the support bar 220. Thus, the support bars 220 and 320 are duplicates of each other and can be sourced as multiples of the same part or component to reduce cost, complexity, and tooling needs. In other cases, however, the support bars 220 and 320 can be different from each other in size, in shape, or in both size and shape and other aspects. The support bar 220 includes a first or right end arm 220A, a second or left end arm 220B, and an extension bar 220C. The extension bar 220C extends between the arms 220A and 220B. The right end arm 220A and left end arm 220B include interlock features 221A and 221B, respectively, that are complimentary in shape. In the arrangement shown, the interlock features of the support bar 220 correspond to and mate with the interlock features of the support bar 320, such that the support bars 220 and 320 will seat and align together within the connector 10. The arms 220A and 220B of the support bar 220 and arms of the support bar 320 define the sides of the front port opening 12 of the connector 10.

The support bar 220 includes a number of molding interlocks, such as the interlock apertures 222A-222F, among others. The support bar 220 also includes a number of terminal seat surfaces, such as the terminal seat surfaces 223A-223C, among others. The support bar 220 also includes terminal recesses between the terminal seat surfaces. Terminal recesses 224A and 224B are shown between the terminal seat surfaces 223A-223C in FIG. 4, among others. The support bar 320 also includes interlock apertures, terminal seat surfaces, and terminal recesses, as shown in FIG. 4.

Ground conductors in the terminal row 210 can be mechanically and electrically secured (e.g., soldered, welded, adhered, etc.) to the terminal seat surfaces 223A-223C. In that way, the terminal row 210 can be secured with the support bar 220, before the wafer molding inserts 240 and 250 are formed. The terminal row 210 and support bar 220 can then be inserted into a mold fixture, and LCP or another insulating material can be injected into the mold. When the wafer molding inserts 240 and 250 are molded around the terminal row 210, the insulating material of the wafer molding insert 240 also flows into the interlock apertures 222A-222F of the support bar 220, to anchor and secure the wafer molding insert 240 with the support bar 220. As compared to other designs in which only a plastic molding is used to support a row of terminal conductors, the support bar 220 provides additional strength, a higher modulus of elasticity, and thermal stability.

In a similar way, ground conductors in the terminal row 310 can be mechanically and electrically secured to terminal seat surfaces of the support bar 320. The terminal row 310 can be secured with the support bar 320 in that way, before the wafer molding inserts 340 and 350 are formed. When formed, the insulating material of the wafer molding insert 340 flows into the interlock apertures of the support bar 320, such as the interlock aperture 322D, to anchor and secure the wafer molding insert 240 with the support bar 220.

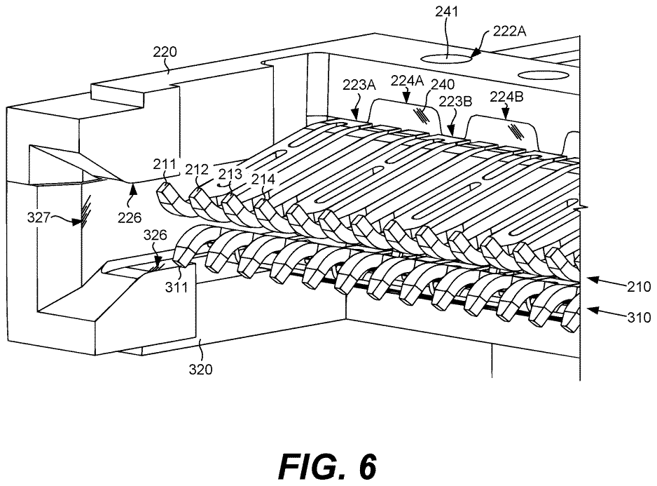

The support bars 220 and 320 also include a number of datum surfaces, from which the positions and surfaces of terminal conductors in the terminal rows 210 and 310 are set with precision according to aspects of the embodiments. For example, the support bar 220 includes a datum surface 226, and the support bar 320 includes datum surfaces 326 and 327. The datum surfaces 226, 326, and 327 provide surface interfaces (or mechanical interfaces or interferences) by which contacts on a PCB-style connector can be aligned with the terminal conductors in the terminal rows 210 and 310, as also described below with reference to FIG. 6.

FIG. 5 illustrates the cross-sectional view A-A of the support bar 320 shown in FIG. 4, taken through the interlock aperture 322D. The interlock aperture 322D is cylindrical and tapered in shape, although it can be formed in other shapes, and extends from an inner surface 329A of the support bar 320 to an outer surface 329B of the support bar 320. The interlock aperture 322D includes a first, narrower tapered aperture 328A that extends from the inner surface 329A to a position within the support bar 320 and a second, wider tapered aperture 328B that extends from within the support bar 320 to the outer surface 329B. Thus, the interlock aperture 322D includes a step or ledge between the narrower aperture 328A and the wider aperture 328B. Each of the other interlock apertures in the support bars 220 and 320 have a similar shape in one example, although the support bars 220 and 320 can include molding interlocks of different types and styles.

As the wafer molding insert 340 is molded around the terminal row 310, the insulating material of the wafer molding insert 340 flows into the interlock aperture 322D, among others in the support bar 320. The wafer molding insert 340 forms a larger cap or interlock plug within the wider aperture 328B, with a mechanical interference between the plug and the step or ledge in the interlock aperture 322D. The wafer molding insert 340 is thus secured with the support bar 320 after the wafer molding insert 340 is formed. The wafer molding insert 240 is also secured with the support bar 220 in a similar way, based on a flow of material from the wafer molding insert 240 extending into the apertures 222A-222F of the support bar 220.

FIG. 6 illustrates a detail view of the support bars 220 and 320 and the terminal rows 210 and 310 at one side of the connector 10. The housing 100 and flexible shields 230 and 231 are omitted from view in FIG. 6. The support bars 220 and 320 include datum surfaces, from which the positions and surfaces of terminal conductors in the terminal rows 210 and 310 are set or determined with better precision as compared to other designs. For example, the support bar 220 includes a datum surface 226, and the support bar 320 includes datum surfaces 326 and 327. When a PCB-style tip of a cable system is inserted into the front port opening 12 of the connector 10, the top surface of the PCB can be guided by the datum surface 226, the bottom surface of the PCB can be guided by the datum surface 326, and the side surface of the PCB can be guided by the datum surface 327. Thus, the datum surfaces 226, 326, and 327 provide surface interfaces (or mechanical interferences) by which the PCB and contacts on the PCB can be aligned with the terminal conductors in the terminal rows 210 and 310. The support bars 220 and 320 include the datum surfaces on both the right and left sides of the opening 12 in the front port 110 of the housing 100. Additionally, the support bars 220 and 320 provide a type of ground shield around the terminal rows 210 and 310, in the front port 110 of the housing 100, because the support bars 220 and 320 are electrically coupled to the ground conductors in the terminal rows 210 and 310.

Terminal conductors 211-214 of the terminal row 210 are referenced in FIG. 6. The terminal conductors 211 and 214 are ground conductors (also “ground conductors 211 and 214”), and the terminal conductors 212 and 213 are a pair of signal conductors (also “signal conductors 212 and 213”) for a differential signal. The signal conductors 212 and 213 are arranged between the ground conductors 211 and 214 in the terminal row 210, and other pairs of signal conductors are also arranged between ground conductors in the terminal row 210.

FIG. 6 illustrates how the top surfaces of the ground conductors 211 and 214 contact the terminal seat surfaces 223A and 223B of the support bar 220. The ground conductors 211 and 214 can be soldered, welded, or otherwise adhered to the terminal seat surfaces 223A and 223B before the wafer molding insert 240 is formed. The signal conductors 212 and 213, on the other hand, pass under the terminal recess 224A of the support bar 220, without contacting the support bar 220. Other signal conductors in the terminal row 210 also pass under terminal recesses in the support bar 220.

When the wafer molding insert 240 is formed, material flows into the terminal recess 224B of the support bar 220, surrounding the signal conductors 212 and 213 along a length of the signal conductors 212 and 213. The material also flows into the interlock aperture 222A to form the interlock plug 241. Thus, the wafer molding insert 240 both electrically isolates the signal conductors 212 and 213 from the support bar 220 and also secures the signal conductors 212 and 213 to the support bar 220. A high degree of precision can be achieved between the datum surfaces 226, 326 and 327 of the support bar 220 and the terminal conductors in the terminal row 210 based on the structural design and assembly approach of the connector 10. The wafer assemblies 200 and 300 are secured with the support bars 220 and 320, respectively, in a similar way, and the support bars 220 and 320 provide a number of advantages, including additional strength and dimensional accuracy for the terminal rows 210 and 310 and the wafer assemblies 200 and 300.

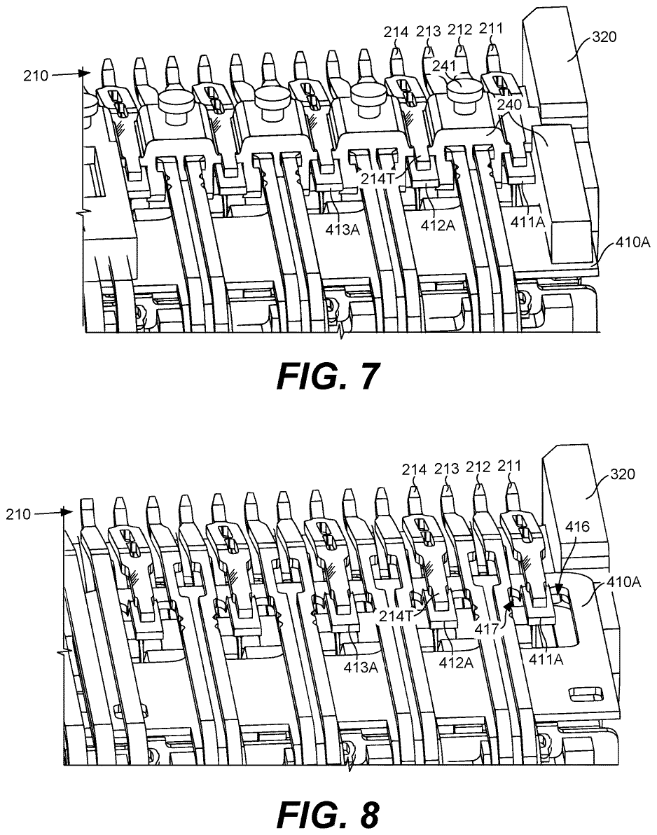

FIG. 7 illustrates a detail view of the terminal row 210 and wafer molding insert 240 of the connector 10 shown in FIG. 1. The housing 100, the support bar 220, and the upper ground channel block 400A are omitted from view in FIG. 7. FIG. 8 illustrates another detail view of the terminal row 210 shown in FIG. 7, with the wafer molding insert 240 also omitted from view. FIG. 7 illustrates how pairs of signal conductors, such as the signal conductors 212 and 213, pass through the wafer molding insert 240 (i.e., the wafer molding insert 240 is formed around the signal conductors 212 and 213). However, the top surfaces of the ground conductors, such as the ground conductors 211 and 214, are not enveloped or surrounded by the wafer molding insert 240. Instead, the top surfaces of the ground conductors 211 and 214 can be soldered, welded, or otherwise adhered to the terminal seat surfaces 223A and 223B of the support bar 220 (see FIG. 6). In that way, the ground conductors 211 and 214 are electrically coupled to the support bar 220.

Referring to FIG. 8, the ground frame 410A includes ground contact platforms 411A-413A, among others. The ground contact platforms 411A-413A are bent or otherwise formed to extend up from a major surface of the ground frame 410A. The top surfaces of the ground contact platforms 411A-413A contact bottom surfaces of ground conductors in the terminal row 210 when the connector 10 is assembled. For example, the top surfaces of the ground contact platforms 411A and 412A contact bottom surfaces of the ground conductors 211 and 214. In that way, the ground conductors 211 and 214 are electrically coupled to the ground frame 410A, and the ground frame 410A is assembled or integrated with the upper ground channel block 400A, both of which are parts of the ground path assembly for the wafer assembly 200. The ground frame 410A, upper ground channel block 400A, and other ground frames and ground channel blocks in the connector are described in more detail below with reference to FIGS. 13-16.

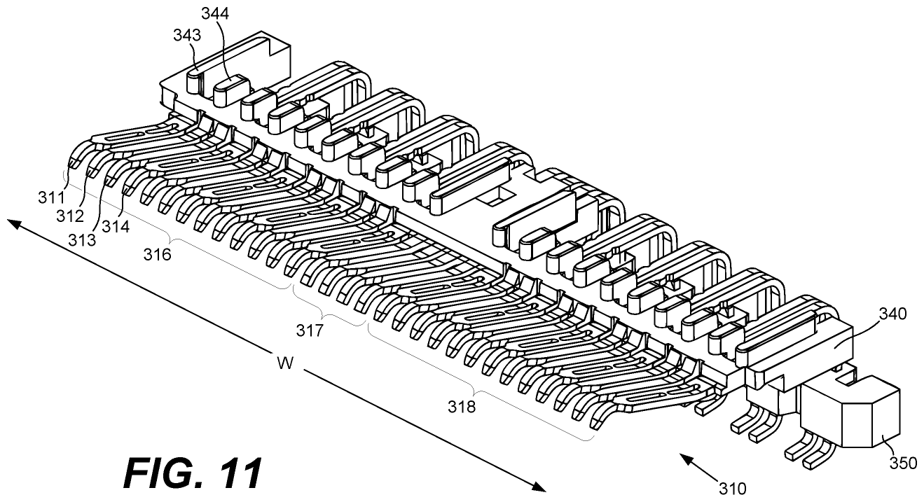

The ground frame 410A also includes interface apertures on the sides of the ground contact platforms. For example, the ground frame 410A includes interface apertures 416 and 417 on the sides of the ground contact platform 411A. Interface plugs on the wafer molding insert 240 can be positioned within the interface apertures of the ground frame 410A when the connector 10 is assembled. The ground frames 410B, 510A, and 510B also include interface apertures, and the wafer molding insert 340 of the wafer assembly 300 also includes interface plugs. Examples of the interface plugs on the wafer molding insert 240 are described below with reference to FIG. 10. Examples of the interface plugs on the wafer molding insert 340 are described below with reference to FIG. 11.

FIG. 9 illustrates a top perspective view of the terminal row 210 and the wafer molding inserts 240 and 250, and FIG. 10 illustrates a bottom perspective view of the same. The wafer molding insert 240 extends across a width “W” of the terminal row 210, as shown in FIG. 9. Similarly, the wafer molding insert 250 extends across the width “W” of the terminal row 210, as shown in FIG. 10. The terminal row 210 and wafer molding inserts 240 and 250 are parts or components of the first or upper wafer assembly 200 in the connector 10.

The terminal row 210 includes a first or right group 216 of terminal conductors, a central group of terminal conductors 217, and a second or left group 218 of terminal conductors. The groups 216 and 217 include ground and signal conductors. Among others, the group 216 includes a ground conductor 211, signal conductors 212 and 213 which form a differential pair of signal conductors, and a ground conductor 214. Collectively, the group 216 includes eight signal conductors and five ground conductors, with each pair of the signal conductors being positioned between two ground conductors. The central group of terminal conductors 217 includes power conductors and, in some cases, can include ground or signal conductors. The group 218 is similar to the group 216 but is positioned on another side of the group 217. The terminal row 310, which is shown in FIG. 11, is similar to the terminal row 210. The pitch between the lead contacts of the terminal conductors is the same in both the terminal rows 210 and 310 in one example. However, the terminal conductors in the terminal row 210 may be offset from those in the terminal row 310, such that the lead contacts are staggered between the rows. In other cases, the terminal conductors in the terminal rows 210 and 310 may have the same pitch and be aligned (i.e., not staggered) with respect to each other. In still other cases, the terminal conductors in the terminal rows 210 and 310 may have different lead contact pitches as compared to each other.

FIG. 10 shows how the signal and power conductors in the terminal row 210 extend, starting from lead contacts within the opening 12 (see FIG. 1), to tail contacts at the terminal foot 13 of the connector 10. As one example, the signal conductor 212 extends from a lead contact 212L end to a tail contact 212T end of the connector 10. The signal conductor 212 includes a bend 212B between the wafer molding insert 240 and the wafer molding insert 250, as do the other signal and power conductors in the terminal row 210. The tail contacts of the signal and power conductors in the terminal row 210 can be formed as SMT tail contacts, as shown in FIG. 10, or formed as through-hole or other types of contacts. The ground conductors in the terminal row 210 do not directly extend to the terminal foot 13. Instead, the ground conductors extend from lead contacts within the opening 12 to contact points on the ground path assembly for the wafer assembly 200. The ground path assembly includes grounding ribs for surface mounting to a board, as described below.

FIG. 10 also illustrates wafer interface plugs 243 and 244, among others, of the wafer molding insert 240. The interface plugs on the wafer molding insert 240 can be positioned within the interface apertures of the ground frame 410A when the connector 10 is assembled. For example, the wafer interface plugs 243 and 244 shown in FIG. 10 can be positioned within the interface apertures 416 and 417 of the ground frame 410A shown in FIG. 8, as part of the assembly of the connector 10. The interface plugs of the wafer molding insert 240 can be relied upon to secure the wafer assembly 200 with the ground path assembly for the wafer assembly 200. Interface plugs of the wafer molding insert 350 can be relied upon to secure the wafer assembly 300 with the ground path assembly for the wafer assembly 300 in a similar way, as described below.

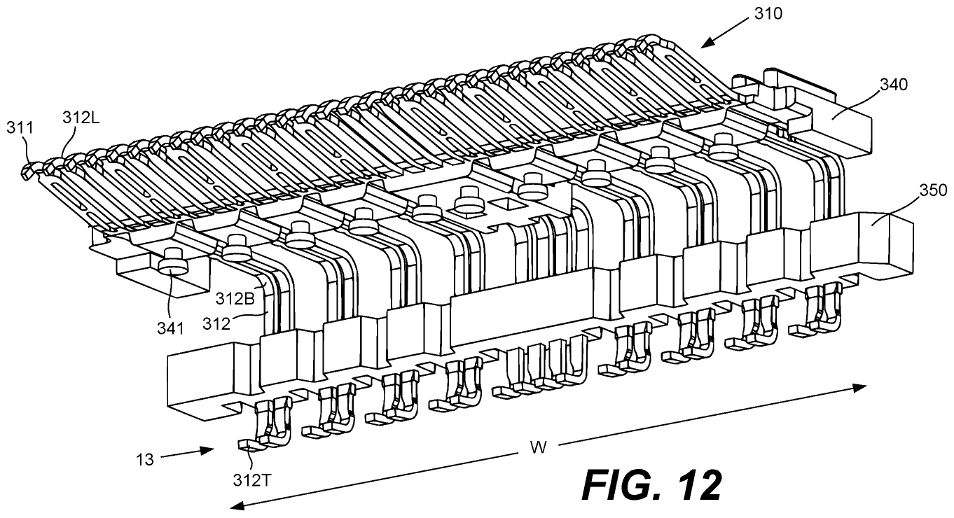

FIG. 11 illustrates a top perspective view of the terminal row 310 and the wafer molding inserts 340 and 350, and FIG. 12 illustrates a bottom perspective view of the same. The wafer molding insert 340 extends across a width “W” of the terminal row 310, as shown in FIG. 11. Similarly, the wafer molding insert 350 extends across the width “W” of the terminal row 310, as shown in FIG. 10. The terminal row 310 and wafer molding inserts 340 and 350 are parts or components of the second or lower wafer assembly 300 in the connector 10.

The terminal row 310 includes a first or right group 316 of terminal conductors, a central group of terminal conductors 317, and a second or left group 318 of terminal conductors. The groups 316 and 317 include ground and signal conductors. For example, the group 316 includes a ground conductor 311, signal conductors 312 and 313 which form a differential pair of signal conductors, and a ground conductor 314. Collectively, the group 316 includes eight signal conductors and five ground conductors, with each pair of the signal conductors being positioned between two ground conductors. The central group of terminal conductors 317 includes power conductors and, in some cases, can include ground or signal conductors. The group 318 is similar to the group 316 but is positioned on another side of the group 317.

FIG. 11 also illustrates wafer interface plugs 343 and 344, among others, of the wafer molding insert 340. The interface plugs on the wafer molding insert 340 can be positioned within the interface apertures of the ground frame 410A when the connector 10 is assembled. The interface plugs of the wafer molding insert 340 can be relied upon to secure the wafer assembly 300 with the ground path assembly for the wafer assembly 300.

FIG. 12 shows how the signal and power conductors in the terminal row 310 extend, starting from lead contacts within the opening 12 (see FIG. 1), to tail contacts at the terminal foot 13 of the connector 10. As one example, the signal conductor 312 extends from a lead contact 312L end to a tail contact 312T end of the connector 10. The signal conductor 312 includes a bend 312B between the wafer molding insert 340 and the wafer molding insert 350, as do the other signal and power conductors in the terminal row 310. The tail contacts of the signal and power conductors in the terminal row 310 can be formed as SMT tail contacts, as shown in FIG. 12, or through-hole or other types of contacts. The ground conductors in the terminal row 310 do not directly extend to the mounting interface 330. Instead, the ground conductors extend from lead contacts within the opening 12 (see FIG. 1) to contact points on the ground path assembly for the wafer assembly 300.

FIG. 13 illustrates a front perspective view of the ground channel blocks 400A, 400B, 450A, 450B, 500A, 500B, 550A, and 550B in the connector 10 shown in FIG. 1, and FIG. 14 illustrates a back perspective view of the blocks. The ground channel blocks 400A, 400B, 450A, and 450B form parts or components of the ground path assembly for the wafer assembly 200, and ground channel blocks 500A, 500B, 550A, and 550B form parts or components of the ground path assembly for the wafer assembly 300. The ground channel blocks 400A, 400B, 450A, 450B, 500A, 500B, 550A, and 550B are separate (i.e., not integrally formed) blocks in the example shown, although one or more of the blocks can be combined or integrally formed together in some cases. For example, the blocks 400A and 450A could be formed as a single block in some cases, and other blocks can be combined. As noted above, the ground channel blocks 400A, 400B, 450A, 450B, 500A, 500B, 550A, and 550B can be formed from LCP, PE, PTFE, conductive PE or PTFE, fluoropolymer, or other plastic or insulating materials.

As shown in FIGS. 13 and 14, the ground channel block 400A includes channels 401C-404C, and the ground channel block 400B includes channels 401D-404D. When the connector 10 is assembled, pairs of signal conductors in the terminal row 210 extend within the channels 401C-404C and 401D-404D in the ground channel blocks 400A and 400B, as also shown in FIG. 3. The channels 401C-404C and 401D-404D help to electrically isolate the pairs of signal conductors in the terminal row 210 from each other, to reduce crosstalk and interference among them.

Similarly, the ground channel blocks 500A and 500B include channels 501C, 502C, 501D, and 502D, among other channels. Pairs of signal conductors in the terminal row 310 extend within the channels 501C and 502C in the ground channel block 500A and within channels 501D and 502D in the ground channel block 500B, among others. Pairs of signal conductors in the terminal row 310 also extend within channels 551C and 552C in the ground channel block 550A and within channels 551D and 552D in the ground channel block 550B, among other channels. The channels in the blocks 500A, 500B, 550A and 550B help to electrically isolate the pairs of signal conductors in the terminal row 310 from each other, to reduce crosstalk and interference among them. Signal conductors in the terminal row 310 extend, starting from lead contacts within the opening 12 (see FIG. 1), through the channels in the ground channel blocks 500A and 500B, through the channels in the ground channel blocks 550A and 550B, to tail contacts at the terminal foot 13 of the connector 10.

Referring to FIG. 14, the ground channel block 450A includes channels 451C-452C, among others, and the ground channel block 450B includes channels 451D-452D, among others. Pairs of signal conductors in the terminal row 210 extend within the channels 451C and 452C in the ground channel block 450A and within channels 451D and 452D in the ground channel block 450B, among other channels. The channels in the blocks 450A and 450B help to electrically isolate the pairs of signal conductors in the terminal row 210 from each other, to reduce crosstalk and interference among them. Signal conductors in the terminal row 210 extend, starting from lead contacts within the opening 12 (see FIG. 1), through the channels in the ground channel blocks 400A and 400B (see FIG. 3), through the channels in the ground channel blocks 450A and 450B, to tail contacts at the terminal foot 13 of the connector 10. The channels in the ground channel blocks 400A, 400B, 450A, 450B, 500A, 500B, 550A, and 550B can also include shifts, bends, or other features, which follow shifts or bends in the signal conductors that extend within them. As examples, FIGS. 13 and 14 show shifts 610 and 612, and other changes in directions of the channels are within the scope of the embodiments.

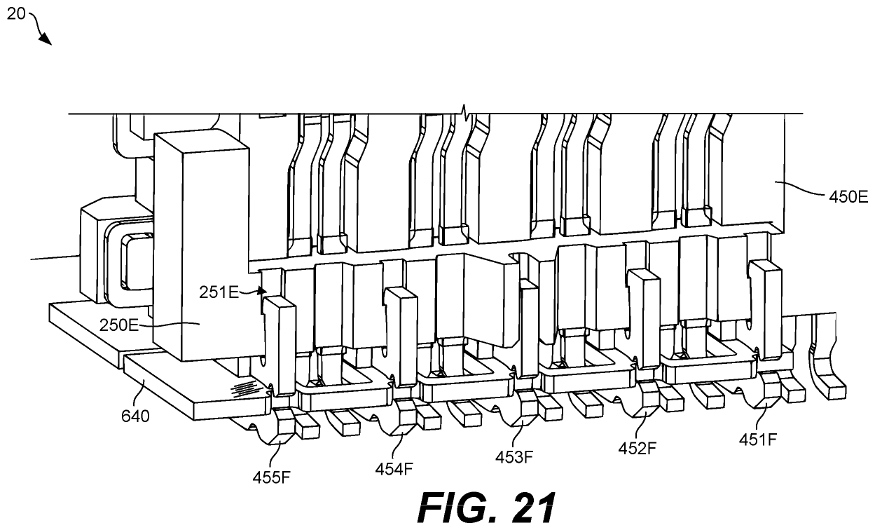

A subset of the ground channel blocks shown in FIGS. 13 and 14 also include grounding ribs at the terminal foot 13 of the connector 10. In the examples shown in FIGS. 13 and 14, the grounding ribs are integrally formed with the ground channel blocks 450A, 450B, 550A, and 550B. Ground channel blocks including separate grounding ribs, formed from metal, can be relied upon in other examples, such as those shown in FIGS. 21-23. As shown in FIG. 13, the ground channel block 550A includes the grounding ribs 551A and 552A, and the ground channel block 550B includes the grounding ribs 551B and 552B, among others. The channel 551C extends between the grounding ribs 551A and 552A of the ground channel block 550A, and other channels of the ground channel block 550A extend between pairs of the grounding ribs of the ground channel block 550A. The channel 551D extends between the grounding ribs 551B and 552B, and other channels of the ground channel block 550B also extend between pairs of the grounding ribs of the ground channel block 550B.

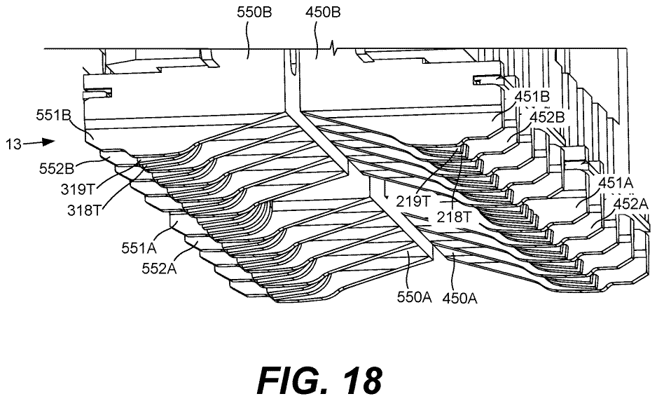

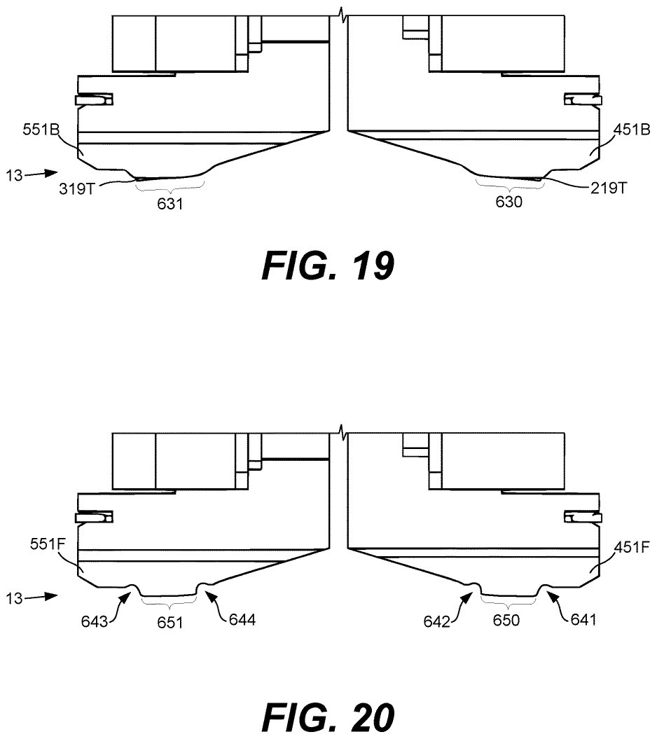

As shown in FIG. 14, the ground channel block 450A includes the grounding ribs 451A and 452A, and the ground channel block 450B includes the grounding ribs 451B and 452B, among others. The grounding ribs can be plated with tin, gold, or another metal plating suitable for surface mounting, and the grounding ribs can be surface mounted to traces on a PCB, along with the SMT tails of the signal and power terminal conductors. The grounding ribs provide shielding between the SMT tails, even at the mounting surface of the terminal foot 13 of the connector 10. The grounding ribs in the ground channel blocks 450A, 450B, 550A and 550B are also described below with reference to FIGS. 18 and 19.

Referring to FIG. 13, the ground channel block 550A also includes a grounding bar 556A, and the ground channel block 550B includes a grounding bar 556B. The grounding bar 556A extends between and is electrically coupled to the grounding ribs of the ground channel block 550A, for ground communing and to maintain a common voltage potential among the grounding ribs. Similarly, the grounding bar 556B extends between and is electrically coupled to the grounding ribs of the ground channel block 550B, for ground communing and to maintain a common voltage potential among the grounding ribs.

Referring to FIG. 14, the ground channel block 450A also includes a grounding bar 456A, and the ground channel block 450B includes a grounding bar 456B. The grounding bar 456A extends between and is electrically coupled to the grounding ribs of the ground channel block 450A, for ground communing and to maintain a common voltage potential among the grounding ribs. Similarly, the grounding bar 456B extends between and is electrically coupled to the grounding ribs of the ground channel block 450B, for ground communing and to maintain a common voltage potential among the grounding ribs.

The grounding bars 456A, 456B, 556A, and 556B can be formed from metal, such as aluminum, copper, zinc, stainless steel, or other metals or metal alloys, and be plated with one or more plating metals in some cases. The ground channel blocks 450A and 450B can be molded around the grounding bars 456A and 456B, in one example, or the grounding bars 456A and 456B can be inserted within slots at the ends of the grounding ribs and secured with interference fits, welds, adhesives, or other means. Similarly, the ground channel blocks 550A and 550B can be molded around the grounding bars 556A and 556B, in one example, or the grounding bars 556A and 556B can be inserted within slots at the ends of the grounding ribs and secured with interference fits, welds, adhesives, or other means.

The ground channel blocks 400A, 400B, 450A, 450B, 500A, 500B, 550A, and 550B can also include a number of corresponding or mating interlock features, such as the interlock features 600 shown in FIG. 13 and interlock features 601 shown in FIG. 14, among others. The interlock features 600 can be used to position, align, and secure pairs of ground channel blocks 400A, 400B, 450A, 450B, 500A, 500B, 550A, and 550B with each other.

FIG. 15 illustrates a front perspective view of ground frames 410A, 410B, 460A, 460B, 510A, 510B, 560A, and 560B in the connector 10 shown in FIG. 1, and FIG. 16 illustrates a back perspective view of the ground frames. The ground frames 410A, 410B, 460A, and 460B form parts or components of the ground path assembly for the wafer assembly 200, and ground frames 510A, 510B, 560A, and 560B form parts or components of the ground path assembly for the wafer assembly 300. The ground frames 410A, 410B, 460A, 460B, 510A, 510B, 560A, and 560B are separate (i.e., not integrally formed) in the example shown, although one or more of the ground frames can be combined and integrated together in some cases. For example, the ground frames 410A and 460A could be formed as a single ground frame in some cases, and other ground frames can be combined.

The ground frames 410A, 410B, 460A, 460B, 510A, 510B, 560A, and 560B can be stamped, sheared, or otherwise formed from a from a flat sheet of metal. In some cases, the sheet of metal can be plated with one or more plating metals. The ground frames 410A, 410B, 460A, 460B, 510A, 510B, 560A, and 560B can be positioned and secured with (e.g., next to, between, against, etc.) the wafer molding inserts 240, 250, 340, and 350 and the ground channel blocks 400A, 400B, 450A, 450B, 500A, 500B, 550A, and 550B, when the connector 10 is assembled. Each of the ground frames 410A, 410B, 460A, 460B, 510A, 510B, 560A, and 560B includes two major side surfaces, which are the two largest surfaces of the ground frames. As examples, major surfaces of the ground frames 410A and 410B are identified using crosshatch lines in FIGS. 15 and 16.

The ground frame 410A includes ground contact platforms 411A-413A, among others. The ground contact platforms 411A-413A are bent or otherwise formed to extend up from a major surface of the ground frame 410A. The top surfaces of the ground contact platforms 411A-413A contact bottom surfaces of ground conductors in the terminal row 210 when the connector 10 is assembled. For example, the top surfaces of the ground contact platforms 411A and 412A contact bottom surfaces of the ground conductors 211 and 214, as also shown in FIG. 8. In that way, the ground conductors 211 and 214 are electrically coupled to the ground frame 410A, and the ground frame 410A is assembled or integrated with the upper ground channel block 400A as parts of the ground path assembly for the wafer assembly 200.

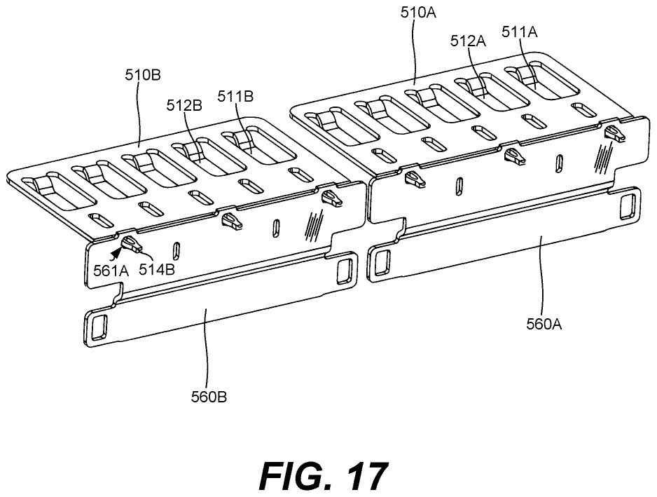

Similarly, the ground frame 410B includes ground contact platforms 411B-413B, among others. The ground contact platforms 411B-413B are bent or otherwise formed to extend up from a major surface of the ground frame 410B. The top surfaces of the ground contact platforms 411B-413B contact bottom surfaces of ground conductors in the terminal row 210 when the connector 10 is assembled. In that way, the ground conductors in the terminal row 210 are coupled to the ground frame 410B, and the ground frame 410B is assembled or integrated with the upper ground channel block 400B as the ground path assembly for the wafer assembly 200. The ground frames 510A and 510B also include ground contact platforms 511A, 512A, 511B, and 512B, among others shown in FIG. 17, that contact the ground terminals in the terminal row 310.

As shown in FIG. 16, the ground frame 410A includes a number of bend tabs, including bend tab 414A, among others, that are mechanically and electrically coupled with coupling tabs of the ground frame 460A when the connector 10 is assembled, using an interference fit. The bend tab 414A is mechanically and electrically coupled with the coupling tab 461A of the ground frame 460A, as one example shown in FIG. 16. The ground frame 510A is also mechanically and electrically coupled with the ground frame 560A, and the ground frame 510B is also mechanically and electrically coupled with the ground frame 560B. As shown in FIG. 17, the ground frame 560B includes a number of eyelets, such as the eyelet 561A, and the ground frame 510B includes a number of ground pins, such as the ground pin 514B. The ground pin 514B is inserted through the eyelet 561A, to mechanically and electrically couple the ground frames 510B and 560B together. The ground frames 510A and 510B are coupled together in a similar way. Although FIGS. 15-17 illustrate example ground frames and approaches to couple the ground frames with each other, other sizes, shapes, and styles of frames can be relied upon. The ground frames can also be electrically coupled to each other in other ways, using mechanical interfaces and fit arrangements.

The ground frames 410A, 410B, 460A, 460B, 510A, 510B, 560A, and 560B can be secured with the wafer molding inserts 240, 250, 340, and 350 and the ground channel blocks 400A, 400B, 450A, 450B, 500A, 500B, 550A, and 550B in a variety of ways. Referring to FIG. 16 for an example, the ground frame 460B includes a mounting aperture 620 at one end, and the ground frame 560B includes a mounting aperture 622 at one end. Mounting posts or plugs of the wafer molding inserts 250 and 350 can be molded or inserted through the apertures 620 and 622, for example, to help secure the ground frames 460B and 560B into position with the wafer molding inserts 250 and 350. Each of the ground frames 410A, 410B, 460A, 460B, 510A, 510B, 560A, and 560B includes one or more mounting apertures, and other features can be relied upon to position the ground frames within the connector 10. The mounting apertures can also be omitted in some cases.

FIG. 18 illustrates a perspective view of the terminal foot 13 of the connector 10 shown in FIG. 1. As shown, the ground channel blocks 450A, 450B, 550A, and 550B include grounding ribs. For example, the ground channel blocks 450A and 450B include grounding ribs 451A and 452A of the block 450A and grounding ribs 451B and 451B of the block 450B, among others. The ground channel block 550A includes the grounding ribs 551A and 552A, among others, and the ground channel block 550B includes the grounding ribs 551B and 552B, among others. The grounding ribs of the ground channel blocks 450A, 450B, 550A, and 550B can be plated with tin, gold, or another metal plating suitable for surface mounting using tin, cadmium, zinc, indium, or other types of solders.

Due to the relatively large surface areas of the grounding ribs, the grounding ribs help to electrically isolate the tail contacts or ends of the terminal conductors in the terminal rows 210 and 310, down to the PCB or other assembly to which the connector 10 is mounted at the terminal foot 13. For example, the tail contacts 318T and 319T are positioned between the grounding ribs 551B and 552B, and the grounding ribs 551B and 552B help to maintain electrical separation between the signals on the tail contacts 318T and 319T. Similarly, the tail contacts 218T and 219T are positioned between the grounding ribs 451B and 452B, and the grounding ribs 451B and 452B help to maintain electrical separation between the signals on the tail contacts 218T and 219T.

The side profiles of the grounding ribs can be formed to track or coincide with the side profiles of the tail contacts in the terminal rows 210 and 310 in some cases. For example, as shown in FIG. 19, the side profiles of the grounding ribs 451B and 551B track the side profiles of the tail contacts 219T and 319T, along the bottom edge length 630 of the grounding rib 451B and the bottom edge length 631 of the grounding rib 451B, respectively. Thus, when the terminal foot 13 of the connector 10 is placed upon the top surface of a PCB or other assembly for surface mounting, both the edge lengths 630 and 631 of the grounding ribs 451B and 551B and the tail contacts 219T and 319T of the terminal rows 210 and 310 make contact with the PCB.

The grounding ribs of the connector 10 can include other features to help with surface mounting. For example, FIG. 20 illustrates a side view of grounding ribs 451F and 551F, which present an alternate example of grounding ribs. The grounding rib 451F includes curved recesses 641 and 642, and the grounding rib 551F includes curved recesses 643 and 644. The curved recesses 641 and 642 of the grounding rib 451F are at opposite ends of the bottom edge length 650 of the grounding ribs 451F, and the curved recesses 643 and 644 of the grounding rib 551F are at opposite ends of the bottom edge length 651 of the grounding rib 551F. The recesses 641-644 provide areas for solder, for example, or other electrical couplings to flow and secure around the edge lengths 650 and 651 of the grounding ribs 451F and 551F.

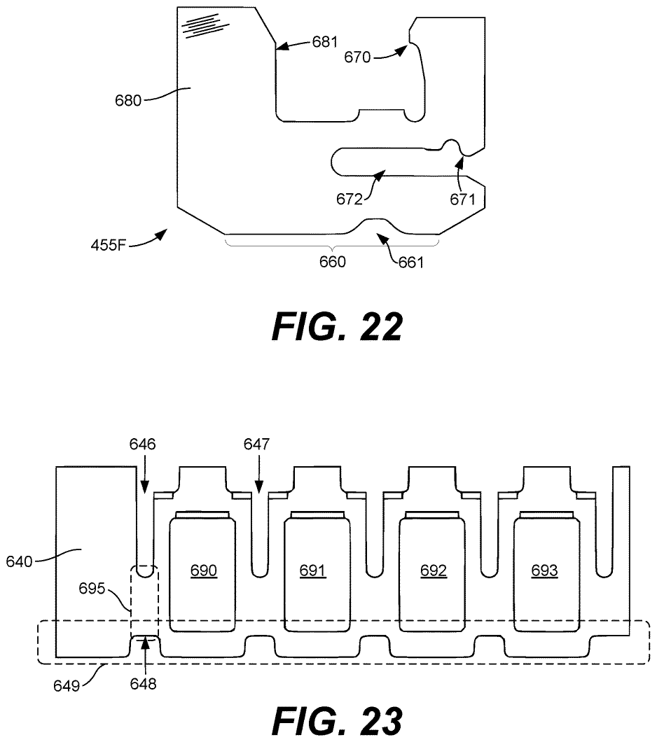

FIG. 21 illustrates a partial view of another connector 20. The connector 20 is similar to the connector 10 but includes metal grounding ribs and a ground platform. In the connector 20, each ground channel block includes grounding ribs and a platform frame. In FIG. 21, the ground channel block 450E is similar to the ground channel block 450B in the connector 10, as described above. However, the ground channel block 450E includes grounding ribs 451F-455F, which are formed as metal rib inserts. The grounding ribs 451F-455F can be formed (e.g., stamped, sheared, or otherwise formed) from metal, such as aluminum, copper, zinc, stainless steel, or other metals or metal alloys, and be plated with one or more plating metals in some cases. A side view of the grounding rib 455F is shown in FIG. 22.

The grounding ribs 451F-455F are not integrally formed with the ground channel block 450E, as the grounding ribs 451B and 451B were integrally formed with the ground channel block 450B. Instead, the grounding ribs 451F-455F are fitted around the wafer molding insert 250E and the ground channel block 450E. The wafer molding insert 250E includes a number of seating channels, such as the seating channel 251E, among others. The grounding rib 455F includes a rib tooth 670 (see FIG. 22), which seats into a lower ledge of the seating channel 251E, forming an interference fit between the grounding rib 455F and the wafer molding insert 250E. The ground channel block 450E also includes a channel or slot, and a rib tab 680 (see FIG. 22) of the grounding rib 455F slides into the channel or slot of the ground channel block 450E, to help secure it in place. The other grounding ribs 451F-454F are also secured with the wafer molding insert 250E and the ground channel block 450E in a similar way.

The example shown in FIG. 21 also includes a ground platform frame 640. At least one major surface of the ground platform frame 640 extends in a plane that is parallel to major surfaces of the grounding ribs 451F-455F. For reference, a major surface of the ground platform frame 640 is identified using crosshatch lines in FIG. 21, and a major surface of the grounding rib 455F is identified using crosshatch lines in FIG. 22. The ground platform frame 640 includes a number of openings 690-693 (see FIG. 23) and a communing bar 649 (see FIG. 23) that extends across the grounding ribs 451F-455F and over the tail ends of the signal conductors, as shown in FIG. 21. The ground platform frame 640 can be formed from metal, such as aluminum, copper, zinc, stainless steel, or other metals or metal alloys, and be plated with one or more plating metals in some cases.

FIG. 22 illustrates a side view of the grounding rib 455F, and FIG. 23 illustrates a top view of the ground platform frame 640. The grounding rib 455F includes a bottom edge length 660 for surface mounting. The bottom edge length 660 of the grounding rib 455F can have other side profile shapes or styles, as compared to that shown, including angled lengths. The bottom edge length 660 includes a curved recess 661, which provides an area for solder, for example, to flow. The bottom edge length 660 of the grounding rib 455F can also have additional recesses in some cases, similar to the examples shown in FIG. 20.

The grounding rib 455F also includes a rib tab 680. The rib tab 680 can be inserted into a channel or slot of the ground channel block 450E (see FIG. 21), and the abutment edge of the rib tab 680 can contact a back surface in the channel or slot. The rib tab 680 also extends into a channel 646 in the ground platform frame 640, as shown in FIG. 23. Rib tabs of other grounding ribs can extend into other channels in the ground platform frame 640. For example, a rib tab of the grounding rib 454F can extend into the channel 647 of the ground platform frame 640, and so on.

The grounding rib 455F also includes a rib tooth 670, which seats into the lower ledge of the seating channel 251E of the wafer molding insert 250E (see FIG. 21), forming an interference fit between the grounding rib 455F and the wafer molding insert 250E. Additionally, the grounding rib 455F includes a communing channel 672. Referring among FIGS. 22 and 23, an interlock region 695 of the ground platform frame 640 is inserted into the communing channel 672 of the grounding rib 455F, when the connector is assembled. Similar interlock regions of the ground platform frame 640 can be inserted into the communing channels of the grounding ribs 451F-454F. A communing tooth 671 of the grounding rib 455F is seated against the front edge 648 of the interlock region 695, to electrically and mechanically secure the grounding rib 455F with the ground platform frame 640. When the connector 20 is assembled, signal conductors can extend down and through the openings 690-693 in the ground platform frame 640, and the communing bar 649 extends across the grounding ribs 451F-455F and over the tail ends of the signal conductors, as shown in FIG. 21.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A connector, comprising:
a housing;
a wafer assembly comprising a terminal row and a wafer molding insert, the terminal row comprising a plurality of terminal conductors; and
a wafer assembly support bar, the wafer assembly support bar comprising a terminal seat surface,
a datum surface, and a molding interlock, wherein:
a terminal conductor among the plurality of terminal conductors is electrically coupled to the terminal seat surface of the wafer assembly support bar; and
the wafer molding insert extends into the molding interlock of the wafer assembly support bar to secure the terminal row with respect to the datum surface.

2. The connector according to claim 1, wherein:
the wafer assembly support bar comprises metal; and
the wafer molding insert comprises plastic.

3. The connector according to claim 1, wherein:
the wafer assembly support bar comprises a first arm, a second arm, and an extension bar that extends between the first arm and the second arm; and
the first arm and the second arm define sides of a port opening of the connector.

4. The connector according to claim 3, wherein:
the extension bar of the wafer assembly support bar comprises the molding interlock; and
at least one of the first arm and the second arm comprises the datum surface.

5. The connector according to claim 1, wherein:
the plurality of terminal conductors comprise a plurality of ground conductors and a plurality of signal conductors;
the wafer assembly support bar comprises a plurality of terminal seat surfaces; and
individual ones of the plurality of ground conductors are electrically coupled to respective ones of the plurality of terminal seat surfaces.

6. The connector according to claim 5, wherein the wafer assembly support bar further comprises a terminal recess positioned between a pair of the plurality of terminal seat surfaces.

7. The connector according to claim 6, wherein a pair of signal conductors among the plurality of signal conductors extends through the terminal recess of the wafer assembly support bar, surrounded by the wafer molding insert.

8. The connector according to claim 1, further comprising:
a ground path assembly, wherein:
the ground path assembly comprises a ground channel block;
the ground channel block comprises a plurality of channels; and
a pair of signal conductors among the plurality of terminal conductors extend along a channel among the plurality of channels.

9. The connector according to claim 8, wherein the ground channel block comprises metal plating over a plastic body.

10. The connector according to claim 8, wherein:
the ground channel block comprises a plurality of grounding ribs for surface mounting at a terminal foot of the connector; and
the channel extends between a pair of the plurality of grounding ribs at the terminal foot of the connector.

11. The connector according to claim 10, wherein the ground channel block comprises a grounding bar that extends between and is electrically coupled to the plurality of grounding ribs of the ground channel block.

12. The connector according to claim 10, wherein the plurality of grounding ribs are integrally formed with the ground channel block.

13. The connector according to claim 10, wherein:
the ground channel block comprises metal plating over a plastic body; and
the plurality of grounding ribs are separate from the ground channel block and formed from metal.

14. The connector according to claim 13, wherein:
the ground path assembly further comprises a ground platform frame; and
major surfaces of the ground platform frame extend in a plane that extends parallel to major surfaces of the plurality of grounding ribs at a terminal foot of the connector.

15. A connector, comprising:
a wafer assembly comprising a terminal row and a wafer molding insert; and
a wafer assembly support bar, the wafer assembly support bar comprising a molding interlock,
wherein the wafer molding insert extends into the molding interlock of the wafer assembly support bar.

16. The connector according to claim 15, wherein:
the wafer assembly support bar further comprises a terminal seat surface; and
a ground conductor of terminal row is electrically coupled to the terminal seat surface of the wafer assembly support bar.

17. The connector according to claim 15, wherein:
the wafer assembly support bar comprises metal;
the wafer molding insert comprises plastic;
the wafer assembly support bar comprises a first arm, a second arm, and an extension bar that extends between the first arm and the second arm; and
the first arm and the second arm define sides of a front port opening of the connector.

18. The connector according to claim 15, further comprising:
a ground path assembly, wherein:
the ground path assembly comprises a ground channel block;
the ground channel block comprises a channel; and
a pair of signal conductors of the terminal row extend along the channel.

19. The connector according to claim 18, wherein:
the ground channel block comprises a plurality of grounding ribs for surface mounting at a terminal foot of the connector; and
the channel extends between a pair of the plurality of grounding ribs at the terminal foot of the connector.

20. The connector according to claim 19, wherein the ground channel block comprises a grounding bar that extends between and is electrically coupled to the plurality of grounding ribs of the ground channel block.
